(19) United States
(12) Patent Application Publication
(10) Pub. No.: US 2026/0257611 A1
(43) Pub. Date: Sep. 3, 2026

(54) HEADLIGHT ARRANGEMENT FOR A VEHICLE

(71) Applicant: MERCEDES-BENZ GROUP AG, Stuttgart (DE)

(72) Inventor: Jens MERTENS, Ostfildern (DE)

(21) Appl. No.: 19/164,803

(22) PCT Filed: Jan. 24, 2024
(86) PCT No.: PCT/EP2024/051644

§ 371 Date: Sep. 12, 2025

(30) Foreign Application Priority Data
Mar. 13, 2023 (DE) 10 2023 000 933.4

(51) Int. Cl. B60Q 1/00; B60Q 1/28; B60Q 1/34; B60Q 1/50; F21S 41/20; F21S 43/20; F21W 103/10; F21W 103/20; F21W 103/55

(52) U.S. Cl. CPC B60Q 1/0005; B60Q 1/0041; B60Q 1/28; B60Q 1/34; B60Q 1/507; F21S 41/285; F21S 43/265; F21S 43/281; B60Q 2400/30; F21W 2103/10; F21W 2103/20; F21W 2103/55

(57) ABSTRACT

A vehicle headlight arrangement includes a number of light modules. At least one first light module has a flap unit that expose or cover the first light module. At least one second light module is arranged uncovered independently of the flap unit.

### BACKGROUND AND SUMMARY OF THE INVENTION

Exemplary embodiments of the invention relate to a headlight arrangement for a vehicle.

Known headlight arrangements comprise at least one light module, but preferably a plurality of light modules. Since the light modules are visible on an outer surface of the vehicle, they serve design purposes in addition to their lighting function. The design of the headlight arrangements is therefore crucial in achieving the desired appearance of the vehicle. The appearance of the vehicle can be described as its signature. There are therefore various options for the design of the headlight modules.

A headlight having a cover is known from DE 10 2019 007 708 A1. The cover consists of an upper and a lower cover element such that the light emission surface of a headlight can be covered. The cover elements are pivotably mounted and each is provided with a drive unit. This allows the cover elements to be mechanically moved into a closed position and an open position. The design of the vehicle can be influenced by the different arrangement of the cover elements. By way of example, a kind of “winking” effect can be achieved, such that communication with vehicles or people outside the vehicle can take place using the cover elements.

With such known devices, the cover elements must be at least partially open in order to enable basic use of the headlight. In the closed position, no light can be emitted through the headlight that can be detected from outside the vehicle.

Alternatively, a headlight with a cover is described in DE 10 2019 008 729 A1, wherein the cover itself can be switched between an opaque and a transparent state. By way of example, the cover is not visually recognizable if the bodywork is the same color as the opaque state. Furthermore, the cover and the bodywork merge seamlessly into one another so that no transition is visible. In the transparent state, however, the headlight can be distinguished from the bodywork. In such known headlights, the cover is therefore integrated directly into the headlight.

DE 10 2012 108 772 A1 shows a headlight having an operable cover for functional parts of this headlight. The cover consists of a textile element. A similar design is also known from DE 10 2012 107 946 A1. Here, one of the light-emitting elements inside a headlight is covered by an actuator, for example in the form of a shutter or flap that can be rotated around an axis.

In addition, it is known from the prior art to cover headlights as a whole when they are not in use. In this context, reference can be made, for example, to FR 2 387 416 A1, which shows a headlight covered as a whole by two flap elements rotating around an axis. When the structure is opened, these flaps disappear completely inside the bodywork. A similar structure, in which, however, the flap is only opened and does not disappear completely into the bodywork, is also known from U.S. Pat. No. 2,524,442 A.

Exemplary embodiments of the present invention are directed to a headlight arrangement that overcomes the above-mentioned disadvantages and that does not impair or only minimally impairs the individual design of the vehicle.

The core of the headlight arrangement according to the invention is formed by at least one first light module, which is provided with a flap unit, wherein the flap unit can expose or cover the first light module, wherein at least one second light module is arranged uncovered independently of the flap unit. In other words, a moveable flap is proposed that cannot cover all light modules of a headlight arrangement. This is particularly advantageous if there is a design requirement that the light modules should only occupy a small area on the outer skin of the vehicle. The flap unit can therefore cover larger or generally any light modules when they are not in use. In other words, the flap unit can be described as a moveable flap that can be moved in front of a first light module or can expose it.

Each light module can have several light units, which can be of different shapes. In particular, the light units of the second light module can be of any shape and arranged anywhere on the bodywork, as they do not need to be accessible by the flap unit. On the other hand, it is preferable for the first light module to be shaped in such a way that the light units of the first light module are arranged next to each other such that they can all be reached or covered by the flap unit.

It is also conceivable to provide several different flap units that can expose or cover different light units of the first light module independently of one another. Each of the flap units can therefore be designed as provided for in accordance with the invention.

The headlight arrangement is designed for a vehicle, wherein the headlight arrangement comprises a plurality of light modules. Advantageously, in a “normal state”, only those light modules are visible that are necessary for normal use of the vehicle in daylight conditions. In contrast, light modules that are not in continuous use can be concealed by the flap unit. The external appearance of the vehicle can therefore be significantly influenced, wherein the vehicle can be driven even when the flap unit is closed in the “normal state”, also with the support of autonomous driving functions. In particular, daytime running lights, sensors for autonomous driving functions and, for example, a headlight flash can preferably not be covered by the flap unit.

Another advantage is that standard modules can be used for both dipped beam and full beam, which saves costs as they do not need to be adapted to a specific design or model. Furthermore, the flap unit protects the second light module from contamination and damage. This prevents contamination of the main lighting function, which comprises the dipped beam required at night, thereby increasing safety. Additional sensors that are not used during the day can also be arranged behind the flap unit.

According to the invention, the flap unit is guided by two opposing guide tracks. The guide tracks have a straight section and a curved section. This ensures that the flap unit can be moved completely under the bodywork.

The flap unit can, for example, be guided by pin elements in the respective guide track and moved along the guide tracks by a drive. The drive can be an electric drive, a pneumatic drive or a similar type of transmission, such as a coupling transmission.

According to an advantageous development, gearwheels can be used to ensure guidance along the guideways.

Another advantageous design can provide that the flap unit can be moved completely underneath a car body. In this case, the flap unit can, for example, be moved parallel to the car body. This can be ensured in particular by the shape of the guide tracks along which the flap unit moves.

Preferably, the first light module can form a main light module that comprises at least a dipped beam, a full beam, a cornering light, and/or an adaptive drive beam. The first light module thus comprises lighting elements that are not used continuously in “normal use”. By way of example, the dipped beam is only used at certain times of the day or night. Similarly, the full beam is not used continuously. The Adaptive Drive Beam (ADB) is an additional headlight that supports a main lighting function. This main lighting function can be, in particular, the full beam or a so-called partial full beam, which is also known as permanent high beam, for example.

According to a very advantageous development of the idea, it can be provided that the second light module has a daytime running light, a position light, a flash, a direction indicator, and/or an autonomous drive system marker light. The second light module therefore forms a distinguishing feature of the vehicle design. In contrast to the first light module, the second light module can be designed to be smaller, such that there are fewer limitations on the design. The second light module can comprise several light units arranged independently of each other on the outer skin of the vehicle. An autonomous drive system marker light (ADS marker light) is a light source that is required for an autonomous driving system. In particular, they enable detected objects to be identified and tracked even better. Visible light or infrared light can be used for this purpose.

The transparent part of the light unit, the light disc, can possibly be made of PMMA, which is located behind the flap unit and is not constantly exposed to stone chips. The light disc can also be made of PMMA only in part.

The flap unit can be moved outwards or inwards. The flap unit can be attached to the bodywork bumper or to the light unit.

According to a very advantageous development of the idea, it can be provided that the flap unit, in a closed position, merges substantially seamlessly into a surrounding outer skin of the vehicle, such that the flap unit does not visually impair the outer skin. As a result, the flap unit does not impair the vehicle design when closed, such that the area of the first light module in particular can be designed to appear as a continuous outer surface. If the first light module is not visibly arranged next to the second light module, the focus is directed solely to the second light module. The design of the vehicle is therefore not impaired by the first light module.

According to an advantageous embodiment, it can be provided that a surface coverable by the flap unit is larger than a surface of the second light module. In particular, the large light modules of a main light module can therefore be covered when they are not needed. The main light module is in particular a dipped beam and/or a full beam. Consequently, the flap unit can be used to achieve a design during the day that is as elegant as possible, for example. Larger headlight surfaces are not visible or can be concealed.

Another advantageous design can provide that the headlight arrangement can be designed as a front headlight or a rear headlight of the vehicle. Therefore, a rear headlight and a front headlight can also be designed with a corresponding flap unit.

Further advantageous designs of the headlight arrangement according to the invention emerge from the exemplary embodiment, which is described in more detail below with reference to the figures.

The flap unit can be equipped with sealing lips to prevent wind noise and the ingress of water, snow and ice.

### BRIEF DESCRIPTION OF THE DRAWING FIGURES

Here are shown:

FIG. 1 a possible embodiment of a headlight arrangement;

FIG. 2 a further possible embodiment of a headlight arrangement;

FIG. 3 a cross-sectional view through a possible embodiment of a headlight arrangement; and

FIG. 4 the cross-sectional view from FIG. 4 in an open state of the flap unit.

### DETAILED DESCRIPTION

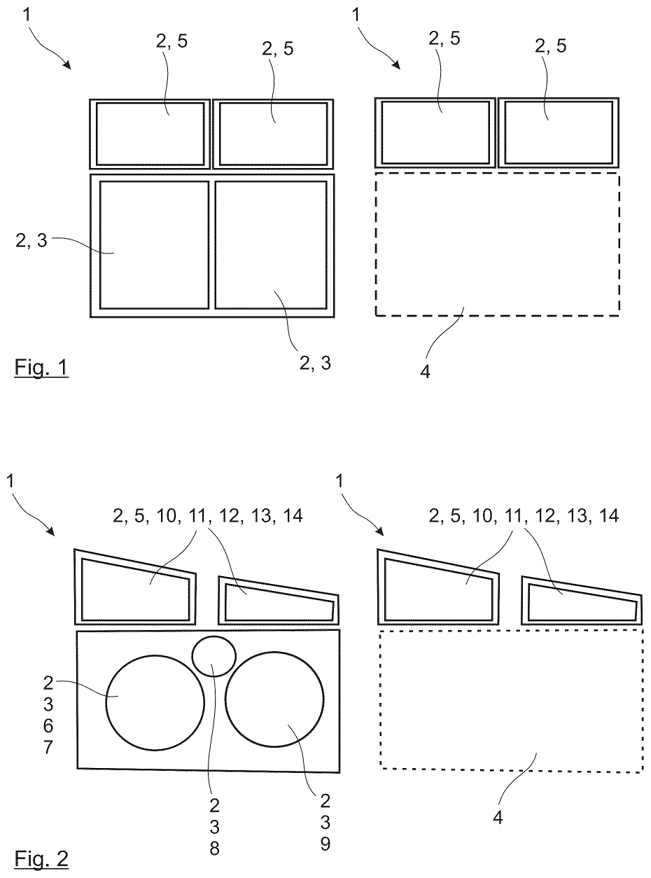

A possible embodiment of the headlight arrangement 1 is depicted in the depiction of FIG. 1. In the left depiction, the headlight arrangement 1 is depicted with an open flap unit 4, wherein the flap unit 4 is not visible. In the right depiction, the headlight arrangement 1 is depicted with a closed flap unit 4, wherein the flap unit 4 covers a part of the headlight arrangement 1. Since the flap unit 4 can blend visually into the outer skin of the vehicle, it is depicted with a dotted line.

In the embodiment according to FIG. 1, the headlight arrangement 1 comprises a first light module 3 and a second light module 5, each comprising two light units 2. The first light module 3 has a larger base area than the second light module 5. In the embodiment depicted, the light modules are arranged one below the other. Another embodiment is also conceivable.

By way of example, in an embodiment not depicted, the arrangement of the light units 2 of each light module 3, 5 can be designed as desired. By way of example, the light units 2 of the second light module 5 can be spaced apart from each other and spaced apart from the first light module 3. This is possible in particular because they do not have to be accessible in front of the flap unit 4. By way of example, the light units 2 of the second light module 5 can be arranged in a circular formation or similar. In contrast, the light units 2 of the first light module 3 are preferably arranged closer together such that they can be covered by a flap unit 4.

Another embodiment variant of the headlight arrangement 1 can be seen in FIG. 2. The same components are marked with the same reference numerals, so there is no need to go into further detail here. In contrast to FIG. 1, the different light functions that can be concealed behind the first light module 3 and the second light module 5 are depicted. By way of example, the first light module 3 can have a dipped beam 6, a full beam 7, a cornering light 8, and an ADB 9. These can be arranged next to each other or one above the other. The second light module 5 can, for example, have a daytime running light 10, a position light 11, a flash 12, a direction indicator 13, and an ADS marker light 14. All of these light units 2 of the second light module 5 can be arranged as desired on the outer skin of the vehicle and do not need to be in direct contact with each other. The right-hand region of the depiction in FIG. 2 shows that the light units 2 of the first light module 3 can be covered by a single flap unit 4.

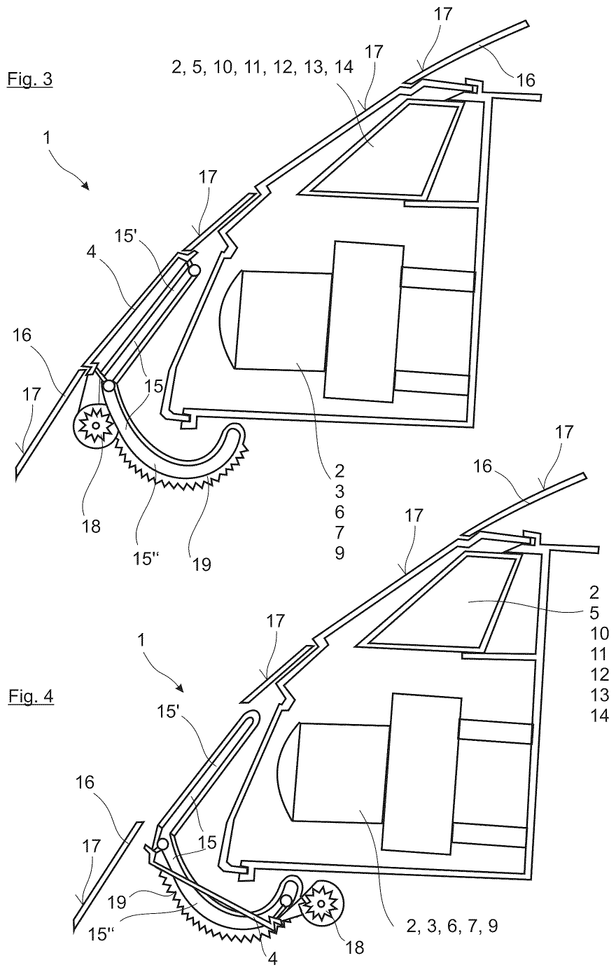

FIG. 3 shows a cross-sectional view of a possible embodiment of a headlight arrangement 1 in a closed state of the flap unit 4. The flap unit 4 merges substantially seamlessly into a surrounding outer skin 17 of the vehicle, such that the flap unit 4 does not visually impair the outer skin 17, or only to a very minor extent. If the first light module 3 is not visibly arranged next to the second light module 5, the focus is directed solely onto the second light module 5. The design of the vehicle is therefore not impaired by the first light module 3.

In the embodiment depicted, the flap unit 4 is guided by two opposite guide tracks 15, wherein the flap unit 4 can be moved under a body 16. Only one guide track 15 is visible in the cross-sectional view depicted.

The flap unit 4 can, for example, by guided by two pin elements in the respective guide track 15 and moved along the guide tracks 15 by means of a drive. In particular, gearwheels 18 can be used to ensure guidance along the guide tracks 15.

The guide track 15 can have a straight section 15′ and a curved section 15″. This ensures, in particular, that the flap unit 4 can be moved completely underneath the body 16, as depicted in FIG. 4. The flap unit 4 can be pivoted relative to the outer skin 17 of the vehicle in order to move under the body. This can be ensured in particular by the shape of the guide tracks 15 along which the flap unit 4 moves.

Teeth 19 can be provided on the curved section 15″ of the guide track 15 such that a gearwheel 18 can engage with them. The gearwheel 18 is connected in particular to the flap unit 4 such that the flap unit can be moved along the guide track 15 by guiding the gearwheel 18 in the teeth 19.

FIG. 4 shows the cross-sectional view from FIG. 3 with the flap unit 4 in an open position. The flap unit 4 is arranged below the body 16, pivoted relative to the outer skin 17, and is not visible from outside the vehicle. This exposes the first light module 3. Since the guide tracks 15 are located next to the first light module 3, in particular to the right and left of it, the light units 2 of the first light module 3 are not affected by the guide tracks 15.

In the embodiment depicted, it can be seen that the first light module 3 and the second light module 5 can be arranged in a common housing. Consequently, the flap unit 4 can be arranged in such a way that it covers part of the housing, namely the part in which the first light module 3 is arranged.

Of course, the described embodiments of the headlight arrangement 1 in FIGS. 1 to 4 can also be combined with each other, resulting in various possibilities. By way of example, the shape of the guide tracks 15, the shape of the light modules 3, 5 and the shape of the flap unit 4 can differ from the embodiment depicted. This ensures, in particular, that differently shaped first light modules 3 can be covered by a flap unit 4 in accordance with the invention.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A headlight arrangement for a vehicle, wherein the headlight arrangement comprises:
a first light module;
a second light module;
a flap unit; and
two opposing guide tracks configured to guide the flap unit, wherein the two opposite guide tracks have a straight section and a curved section, and wherein the two opposing guide tracks are configured to move the flap unit underneath a body of the vehicle.

12. The headlight arrangement of claim 11, wherein the first light module is a main light module comprising at least a dipped beam, a full beam, a cornering light, or an adaptive drive beam.

13. The headlight arrangement of claim 11, wherein the second light module comprises a daytime running light, a position light, a flash, a direction indicator, or an autonomous drive system marker light.

14. The headlight arrangement of claim 11, wherein a transparent part of a light unit of the first light module or of second light module contains a polymethylmethacrylate.

15. The headlight arrangement of claim 11, further comprising:
a gearwheel with teeth arranged on the curved section of the two opposing guide tracks, wherein the teeth are connected to the flap unit.

16. The headlight arrangement of claim 11, wherein the flap unit is moveable inwards or outwards.

17. The headlight arrangement of claim 11, wherein in a closed position, the flap unit merges seamlessly into a surrounding outer skin of the vehicle such that the flap unit does not visually impair the surrounding outer skin.

18. The headlight arrangement of claim 11, wherein the flap unit includes a lip seal.

19. The headlight arrangement of claim 11, wherein a surface of the headlight arrangement coverable by the flap unit is larger than a surface of the second light module.

20. The headlight arrangement of claim 16, wherein the headlight arrangement forms a front headlight or a rear headlight of the vehicle.

21. A vehicle comprising:
a body; and
a headlight arrangement configured on the body, wherein the headlight arrangement comprises
a first light module;
a second light module;
a flap unit; and
two opposing guide tracks configured to guide the flap unit, wherein the two opposite guide tracks have a straight section and a curved section, and wherein the two opposing guide tracks are configured to move the flap unit underneath the body of the vehicle.
